(19) United States
(12) Patent Application Publication
(10) Pub. No.: US 2009/0041535 A1
(43) Pub. Date: Feb. 12, 2009

(54) Universal Joint with Larger Torque Capacity

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/875,016

(22) Filed: Oct. 19, 2007

(30) Foreign Application Priority Data
Aug. 8, 2007 (TW) 96129290

(51) Int. Cl. F16D 3/16

(52) U.S. Cl. 403/57

(57) ABSTRACT

A universal joint includes a pair of yoke members each having a pair of spaced arms. A coupler is pivotably coupled with the arms of the yoke members, allowing the yoke members to respectively pivot about two pivot axes perpendicular to each other. The coupler includes opposite first and second faces slideably abutting with inner faces of the arms of one of the yoke members, opposite third and fourth faces slideably abutting with inner faces of the arms of the other yoke member, and opposite filth and sixth faces. A length of each of the first, second, third, and fourth faces between the fifth and sixth faces is larger than 0.6 times a width between the first and second faces and smaller than a distance from one of the two pivot axes to an intermediate face between the inner faces of the arms of one of the yoke members.

### BACKGROUND OF THE INVENTION

The present invention relates to a universal joint and, more particularly, to a universal joint that may withstand larger torque.

Various universal joints exist for providing power transmission from a power source to a member to be driven. FIGS. 9 through 11 show a conventional universal joint 90 including a pair of yoke members 93 and 95 and a parallelepiped coupler 91. The yoke member 95 includes a power input end 96, and the other yoke member 93 includes a power output end 97 for coupling with a socket. The coupler 91 includes a first through-hole 98 extending through a pair of opposite faces thereof and a second through-hole 99 extending through another pair of opposite faces thereof and orthogonal to but spaced from the first through-hole 98. The coupler 91 is pivotably coupled with the yoke member 93 by a first pin 92 extending through aligned pin holes 930 in a pair of arms 932 of the yoke member 93 and the first through-hole 98 of the coupler 91. Furthermore, the coupler 91 is pivotably coupled with the yoke member 95 by a second pin 94 extending through aligned pin holes 950 in a pair of arms 952 of the yoke member 95 and the second through-hole 99 of the coupler 91. The pivot axis of the first pin 92 does not intersect the pivot axis of the second pin 94. The working angle range of this universal joint is wider when the yoke member 95 is manually driven by the power input end 96. A spacing T between the arms 952 of the yoke member 95 is substantially equal to the width of the coupler 91. A distance L from the center O₁ of the first pin 92 to an end face of the coupler 91 is approximately equal to a half of the spacing T. A distance L from the center O₂ of the second pin 94 to the other end face of the coupler 91 is approximately equal to a half of the spacing T.

However, the distance A1 from the center O₂ of the second pin 94 to the center O₁ of the first pin 92 in the longitudinal direction X of the yoke member 93 changes continuously during operation such that the yoke member 95 continuously shakes up and down relative to the other yoke member 93 that is coupled with a socket for driving a fastener or the like. As a result, this universal joint 90 can only work through manual operation; i.e., this universal joint 90 is not suitable for high speed operation with a power tool.

Another disadvantage of the universal joint 90 is that each arm 932, 952 is liable to deform or even be damaged by torque during operation at a section H between each end face of the coupler 91 and a bottom face between the arms 932, 952. An approach to avoid damage to the arms 932 and 952 is to provide a rounded area 934 at the bottom of each arm 932, 952. However, the rounded areas 934 and 954 can not effectively enhance the torque-withstanding properties of the arms 932 and 953. As a result, the arms 932 and 952 are still liable to deform or even be damaged at the sections H.

FIGS. 12 and 13 show another conventional universal joint 80 including a pair of yoke members 83 and 85 and a cubic coupler 81. The yoke member 85 includes a power input end 86, and the other yoke member 83 includes a power output end 87 for coupling with a socket. The coupler 81 is pivotably coupled with the yoke member 83 by a first pin 82 extending through a pair of arms 832 of the yoke member 83 and through a through-hole that extends through a pair of opposite faces of the coupler 81. Furthermore, the coupler 81 is pivotably coupled with the yoke member 85 by two second pins 84 respectively extending through a pair of arms 852 of the yoke member 85 into two holes respectively in another pair of opposite faces of the coupler 81. The pivot axis of the first pin 82 intersects and is perpendicular to the pivot axis of the second pins 84 to avoid the shaking problem of the conventional universal joint 90 of FIG. 9. Thus, this type of universal joint 80 can be utilized with high-speed power tools. A spacing T between the arms 852 of the yoke member 85 is substantially equal to the length of the cubic coupler 81. A distance L from the center of the pin 82 to each of two opposite end faces of the coupler 81 is equal to a half of the spacing T. Similar to the universal joint 90, each arm 832, 852 of the universal joint 80 is liable to deform or even be damaged by torque during operation at a section H between the end face of the coupler 81 and a bottom face between the arms 832, 852. Deformation and damage at the sections H of the arms 832 and 852 still occur although a rounded area 88 is provided adjacent to the bottom of each arm 832, 852. Taiwan Patent Application No. 92220270 discloses similar devices and, thus, has similar disadvantages as the universal joint 80.

U.S. Pat. No. 5,062,730 discloses a universal joint including a pair of joint bodies having cylindrical hub portions and yoke portions. The hub portions are coupled to a drive shaft and a driven shaft, respectively. Each yoke portion includes a pair of arms having aligned bearing holes into which sleeve members are force-fitted. A coupling member includes a rectangular segment and four pins. Each pin is slidingly inserted into one of the sleeve members and then forcibly inserted by a pressing machine into one of four pin holes respectively in four sides of the segment. Such a universal joint can not withstand high torque, for gaps exist between the coupler and the arms of the yoke portions. Furthermore, the working angle range of the universal joint is relatively small.

A need exists for a universal joint having improved torque capacity while providing a wider working angle range.

### BRIEF SUMMARY OF THE INVENTION

The present invention solves this need and other problems in the field of power transmission by providing, in a preferred form, a universal joint including first and second yoke members. The first yoke member includes a power input end, and the second yoke member includes a power output end. The first yoke member further includes a first coupling end having two mutually facing first inner faces and a first intermediate face interconnected between the first inner faces. The second yoke member further includes a second coupling end having two mutually facing second inner faces and a second intermediate face interconnected between the second inner faces. A coupler is pivotably coupled with the first and second arms, allowing the first and second yoke members to respectively pivot about two pivot axes perpendicular to each other. The coupler includes opposite first and second faces slideably abutting with the first inner faces of the first yoke member, opposite third and fourth faces perpendicular to the first and second faces and slideably abutting with the second inner faces of the second yoke member, and opposite fifth and sixth faces perpendicular to the first, second, third, and fourth faces. A width between the first and second faces is substantially equal to a spacing between the first arms and substantially equal to a width between the third and fourth faces that is substantially equal to a spacing between the second arms. Each of the first, second, third, and fourth faces has a length between the fifth and sixth faces. The length is larger than 0.6 times the width and smaller than a distance from one of the two pivot axes to one of the first and second intermediate faces. The universal joint having such a coupler can withstand higher torque during operation.

The torque capacity of the universal joint according to the preferred teachings of the present invention is higher if the length of each of the first, second, third, and fourth faces is larger than 0.75 times the width and smaller than 0.95 times the distance from one of the two pivot axes to one of the first and second intermediate faces.

In the most preferred form, the coupler further includes a chamfered face on each of two opposite sides of each of the fifth and sixth faces. Each chamfered face on the fifth face has a length extending between the third and fourth faces, and each chambered face on the sixth face has a length extending between the first and second faces.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a universal joint according to the preferred teachings of the present invention.

FIG. 2 shows an exploded perspective view of the universal joint of FIG. 1.

FIG. 3 shows a cross sectional view of the universal joint of FIG. 1 according to section line 3-3 of FIG. 1.

FIG. 4 shows a cross sectional view of the universal joint of FIG. 1 according to section line 4-4 of FIG. 1.

FIG. 5 shows a cross sectional view of the universal joint of FIG. 1 according to section line 5-5 of FIG. 4.

FIG. 6 shows a cross sectional view of the universal joint of FIG. 1 according to section line 6-6 of FIG. 3.

FIG. 7 shows a partially sectioned elevational view of the universal joint of FIG. 1 with two yoke members of the universal joint aligned with each other.

FIG. 8 shows a partially sectioned elevational view of the universal joint of FIG. 1 with the yoke members of the universal joint having an angle therebetween.

FIG. 9 shows an exploded perspective view of a conventional universal joint.

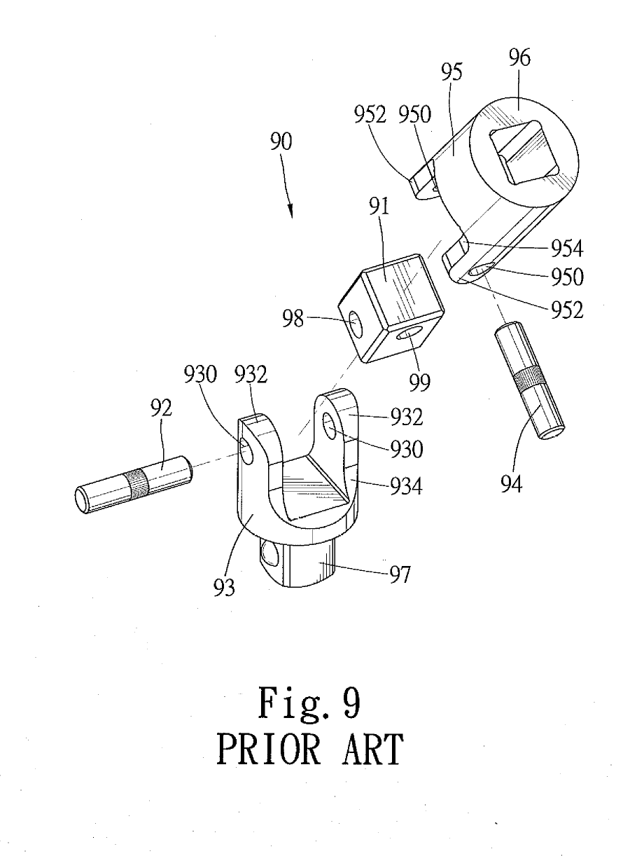

FIG. 10 shows a perspective view of the universal joint of FIG. 9.

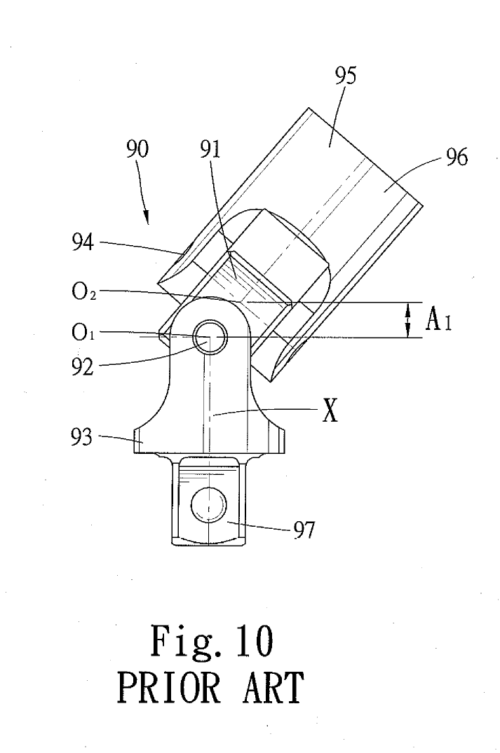

FIG. 11 shows a partially sectioned elevational view of the universal joint of FIG. 9.

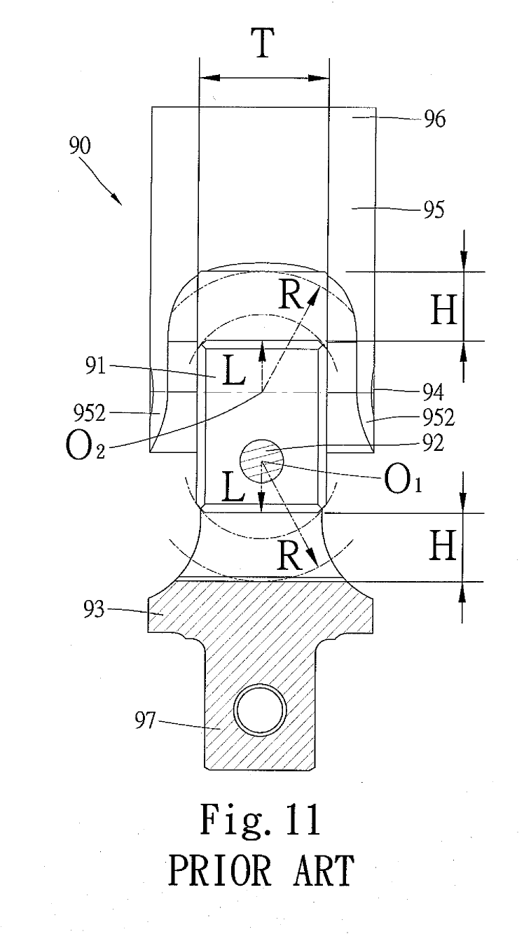

FIG. 12 shows a perspective of another conventional universal joint.

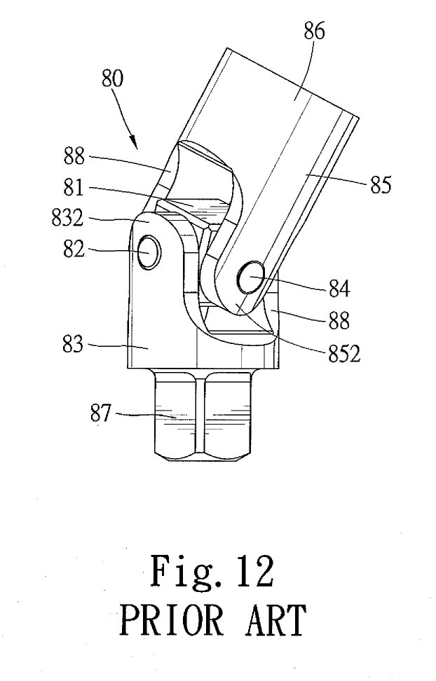

FIG. 13 shows a partially sectioned elevational view of the universal joint of FIG. 12.

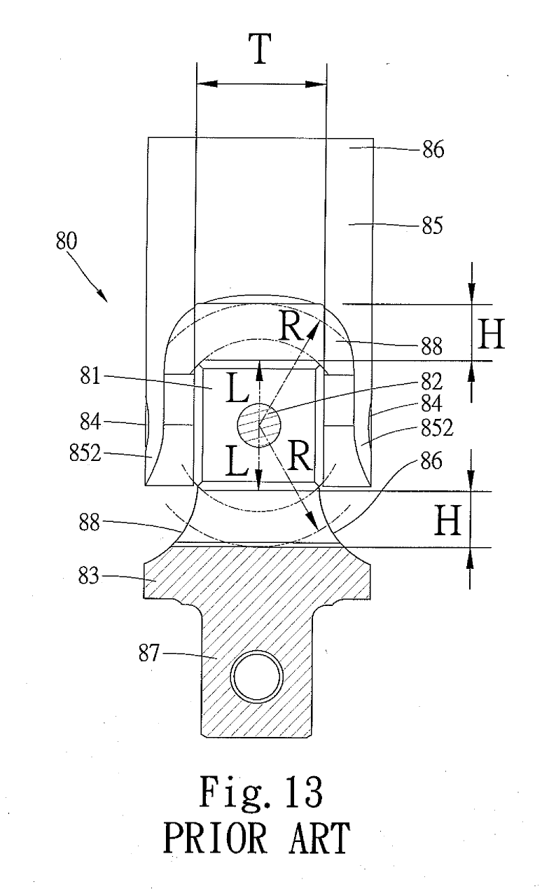

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “end”, “portion”, “section”, “length”, “width”, “spacing”, “inner”, “centrifugal”, “lateral”, “peripheral”, “inward”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

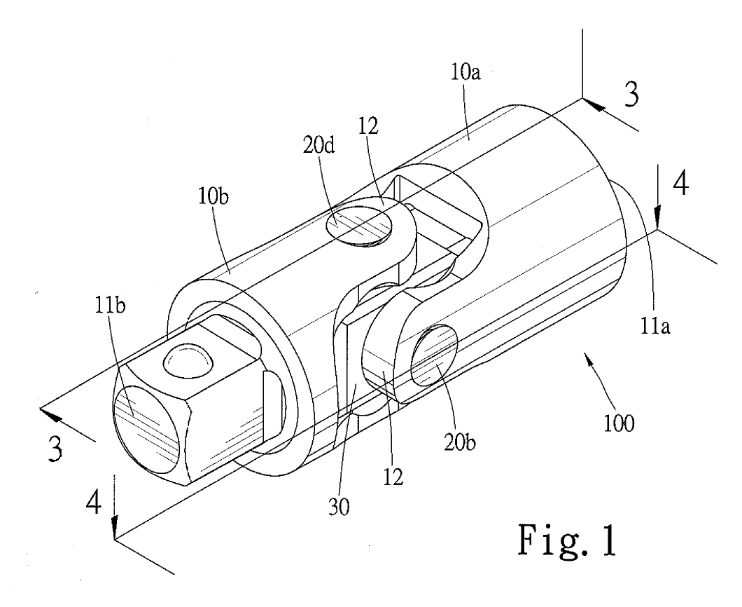

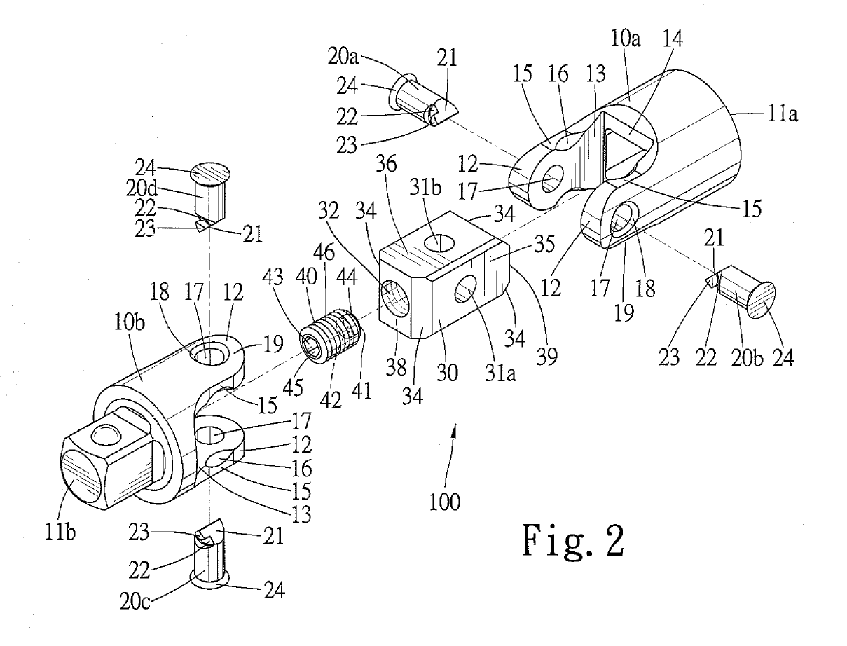

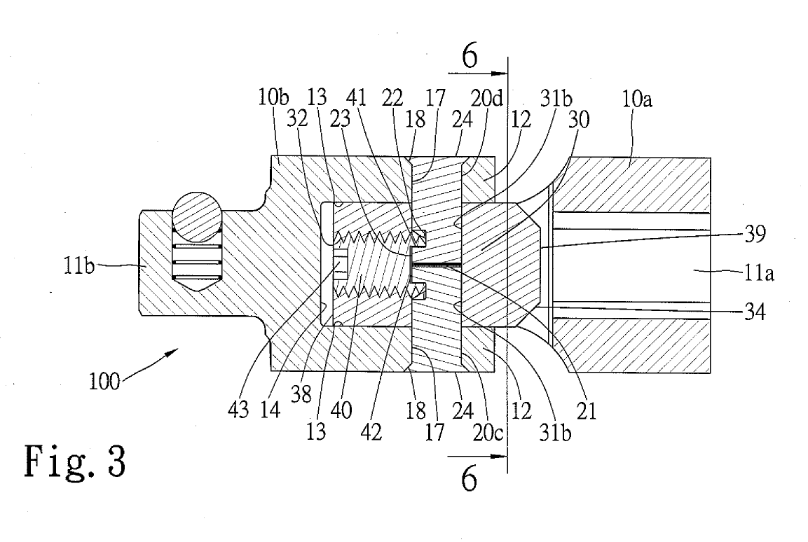

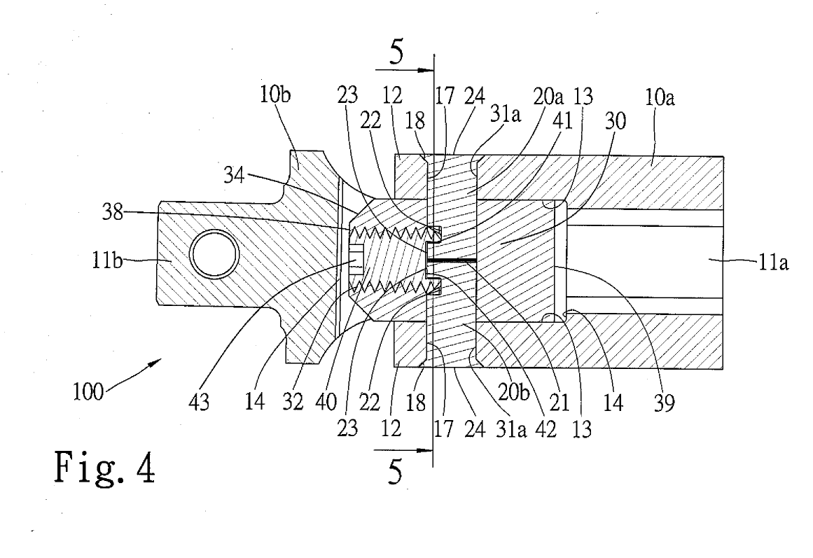

A universal joint according to the preferred teachings of the present invention is shown in FIGS. 1-8 of the drawings and designated 100. The universal joint 100 includes first and second yoke members 10a and 10b. In the preferred form shown, the first yoke member 10a includes a coupling end 19 and a power input end 11a in the form of a socket for coupling with a power tool for high speed operations. Other forms of the power input end 11a would be within the skill of the art. The second yoke member 10b includes a coupling end 19 and a power output end 11b in the form of a drive column for coupling with a socket. Other forms of the power output end 11b would be within the skill of the art. In the most preferred form shown, the coupling ends 19 of the first and second yoke members 10a and 10b are identical. Thus, description of one of the coupling ends 19 would be sufficient.

In the most preferred form shown, the coupling end 19 includes a pair of spaced arms 12 having aligned pivot holes 17 and mutually facing inner faces 13 interconnected by an intermediate face 14 therebetween. Each arm 12 further has two opposite lateral sides 15 between which one of the inner faces 13 extends. A recess 16 is formed between each lateral side 15 of each arm 12 and one of the inner faces 13 of the arm 12. Each recess 16 is located between the intermediate face 14 of a pair of the arms 12 and a pivot axis extending through the pivot holes 17. During transmission of power, the recesses 16 of each yoke member 10a, 10b receive the arms 12 of the other yoke member 10b, 10a. Thus, the angle between the first and second yoke members 10a and 10b can be larger. Namely, the working angle range of the universal joint 100 according to the preferred teachings of the present invention is wider than conventional ones. Each pivot hole 17 includes an outer end with a larger receiving section 18 that has an inner diameter greater than that of the pivot hole 17.

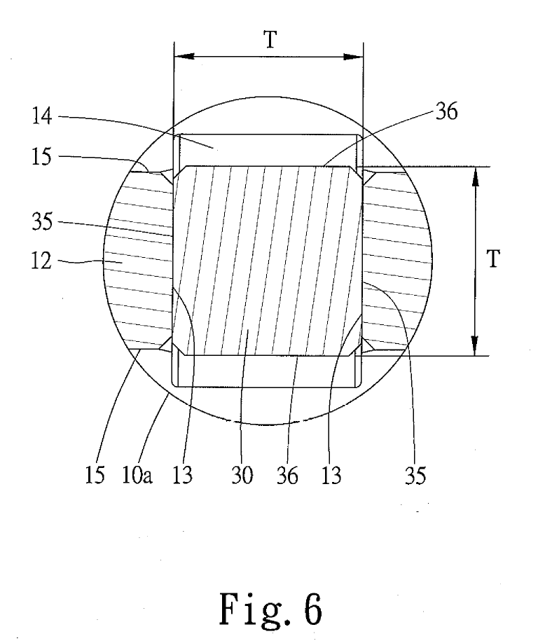

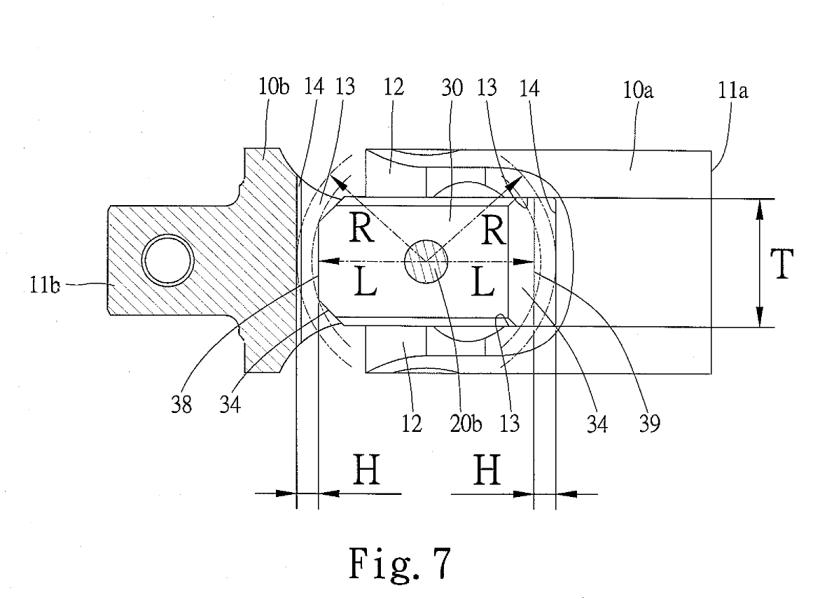

In the preferred form shown, the coupler 30 is a parallelepiped including opposite first and second faces 35, opposite faces third and fourth 36 perpendicular to the first and second faces 35, and fifth and sixth faces 38 and 39 perpendicular to the first, second, third, and fourth faces 35 and 36. A positioning hole 32 is defined in the fifth face 38. In the most preferred form shown, the positioning hole 32 is a screw hole with inner threading. The coupler 30 further includes two first pin holes 31a respectively extending inward from the first and second faces 35. The first pin holes 31a are aligned with each other and in communication with the positioning hole 32. The coupler 30 further includes two second pin holes 31b respectively extending inward from the third and fourth faces 36. The second pin holes 31b are aligned with each other and in communication with the positioning hole 32. A first central axis extending through the aligned first pin holes 31a is coplanar with and orthogonal to a second central axis extending through the second pin holes 31b. A width (FIG. 6) between the first and second faces 35 is substantially equal to a spacing T between the inner faces 13 of the first yoke member 10a. Thus, the first and second faces 35 slideably abut with the inner faces 13 of the first yoke member 10a. A width (FIG. 6) between the third and fourth faces 36 is substantially equal to the width between the first and second faces 35 and is substantially equal to a spacing T between the inner faces 13 of the second yoke member 10b. Thus, the third and fourth faces 36 slideably abut with the inner faces 13 of the second yoke member 10b. The distance from the first central axis to each of the fifth and sixth faces 38 and 39 of the coupler 30 is represented by L (FIG. 7), which is substantially equal to the distance from the second central axis to each of the fifth and sixth faces 38 and 39 of the coupler 30 in the most preferred form shown. Namely, the length of the coupler 30 between the fifth and sixth faces 38 and 39 is 2*L, and each of the first, second, third, and fourth faces 35 and 36 has a length (2*L) between the fifth and sixth faces 38 and 39. A chamfered face 34 is formed on each of two opposite sides of each of the fifth and sixth faces 38 and 39 of the coupler 30. In the most preferred form shown, each of the chamfered faces 34 on the fifth face 38 has a length extending between the third and fourth faces 36, and each of the chamfered faces 34 on the sixth face 39 has a length extending between the first and second faces 35.

The distance from the first central axis to the intermediate face 14 of each yoke member 10a, 10b is represented by R, which is substantially equal to the distance from the second central axis to the intermediate face 14 of each yoke member 10a, 10b in the most preferred form shown. H represents a section of each arm 12 between the intermediate face 14 of each yoke member 10a, 10b and one of the fifth and sixth faces 38 and 39. The relationship of T, L, and R is as follows:

0.6*T<L<R

The universal joint 100 according to the preferred teachings of the present invention having such a coupler 30 can withstand larger torque, for the sections H of the arms 12 of the first and second yoke members 10a and 10b not abutting with the first, second, third, and fourth faces 35 and 36 are relatively small. The universal joint 100 according to the preferred teachings of the present invention has a larger torque capacity if the following relationship is fulfilled:

0.75*T<L<0.95*R

A first pin 20a is extended through the pivot hole 17 of one of the arms 12 of the first yoke member 10a and through one of the first pin holes 31a of the coupler 30 into the positioning hole 32 of the coupler 30. A second pin 20b is extended through the pivot hole 17 of the other arm 12 of the first yoke member 10a and through the other first pin hole 31a of the coupler 30 into the positioning hole 32 of the coupler 30. Thus, the first yoke member 10a is pivotable relative to the coupler 30 about a first pivot axis defined by the first and second pins 20a and 20b. The first pivot axis is coincident to the first central axis extending through the first pin holes 31a. A third pin 20c is extended through the pivot hole 17 of one of the arms 12 of the second yoke member 10b and through one of the second pin holes 31b of the coupler 30 into the positioning hole 32 of the coupler 30. A fourth pin 20d is extended through the pivot hole 17 of the other arm 12 of the second yoke member 10b and through the other second pin hole 31b of the coupler 30 into the positioning hole 32 of the coupler 30. Thus, the second yoke member 10b is pivotable relative to the coupler 30 about a second pivot axis defined by the third and fourth pins 20c and 20d. The second pivot axis is coincident to the second central axis extending through the second pin holes 31b. Furthermore, the second pivot axis is perpendicular to and intersects the first pivot axis.

In the most preferred form shown, the first, second, third, and fourth pins 20a, 20b, 20c, and 20d are identical to each other to allow easy replacement. Each of the first, second, third, and fourth pins 20a, 20b, 20c, and 20d includes an inner end 21 having a groove 22 in an outer periphery thereof and a coupling section 23 having substantially quarter circular cross sections. The first, second, third, and fourth pins 20a, 20b, 20c, and 20d may be formed by any suitable method including but not limited to machining, milling, casting, injection molding, etc. Each coupling section 23 is located on the outer periphery of the inner end 21 of the pin 20a, 20b, 20c, 20d and faces an outer end of the positioning hole 32 of the coupler 30. Each of the first, second, third, and fourth pins 20a, 20b, 20c, and 20d includes an enlarged outer end 24 fittingly received in the receiving section 18 of one of the arms 12 of one of the first and second yoke members 10a and 10b so that the outer end 24 does not extend beyond the outer face of the arm 12.

An engaging member 40 is mounted in the positioning hole 32 of the coupler 30. In the most preferred form shown, the engaging member 40 includes outer threading 46 for threadedly engaging with the inner threading of the positioning hole 32. The engaging member 40 further includes an inner end 41 having an engaging hole 42 defined by a peripheral edge 44. Furthermore, the engaging member 40 includes an outer end 43 having a hexagonal groove 45 for coupling with a hexagonal wrench or the like so that the engaging member 40 can be moved in the positioning hole 32 of the coupler 30 between an engaged position engaged with the first, second, third, and fourth pins 20a, 20b, 20c, and 20d and a free position disengaged from the first, second, third, and fourth pins 20a, 20b, 20c, and 20d. Specifically, when the engaging member 40 is in its engaged position, the coupling sections 23 of the first, second, third, and fourth pins 20a, 20b, 20c, and 20d are engaged with the engaging hole 42 of the inner end 41 of the engaging member 40 whereas the peripheral edge 44 of the inner end 41 of the engaging member 40 is engaged with the grooves 22 of the first, second, third, and fourth pins 20a, 20b, 20c, and 20d. Thus, the first, second, third, and fourth pins 20a, 20b, 20c, and 20d are securely engaged with the engaging member 40 such that disengagement of the first, second, third, and fourth pins 20a, 20b, 20c, and 20d from the coupler 30 is avoided. On the other hand, when the engaging member 40 is moved to the free position, the coupling sections 23 of the first, second, third, and fourth pins 20a, 20b, 20c, and 20d are disengaged from the engaging hole 42 of the inner end 41 of the engaging member 40 whereas the peripheral edge 44 of the inner end 41 of the engaging member 40 is disengaged from the grooves 22 of the first, second, third, and fourth pins 20a, 20b, 20c, and 20d. Thus, the first, second, third, and fourth pins 20a, 20b, 20c, and 20d are disengaged from the engaging member 40 and, thus, removable for repair or replacement purposes.

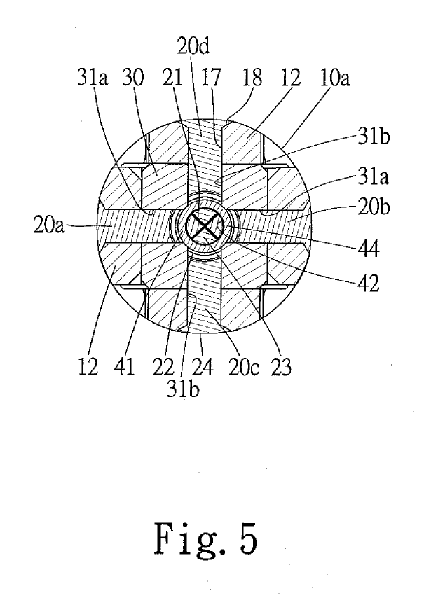

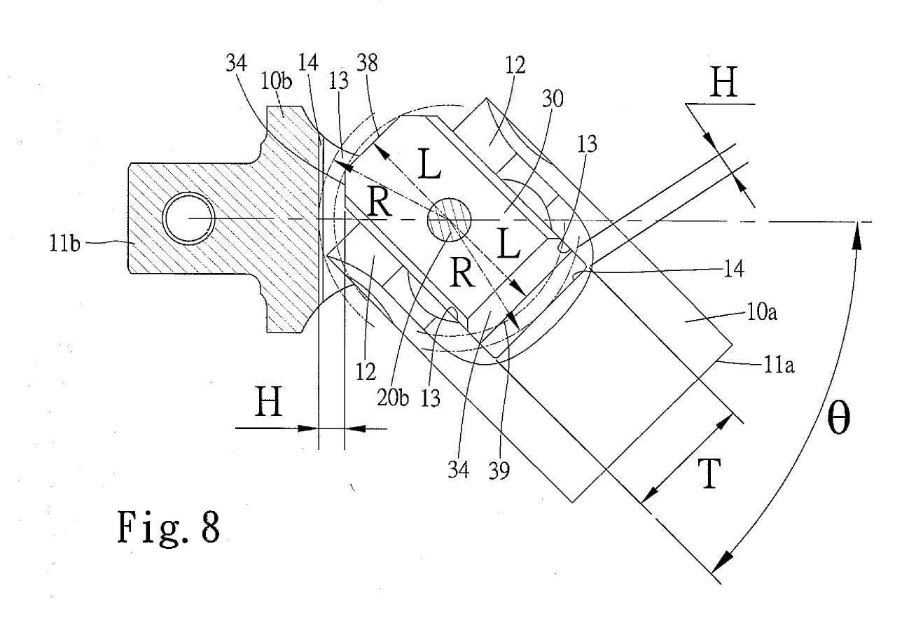

Now that the basic construction of the universal joint 100 of the preferred teachings of the present invention has been explained, the operation and some of the advantages of the universal joint 100 can be set forth and appreciated. When the power input end 11a of the first yoke member 10a is rotated by a power tool, the power is transmitted to the second yoke member 10b for driving a socket for tightening/loosening a fastener or the like. The recesses 16 of the arms 12 of one of the first and second yoke members 10a and 10b can receive the arms 12 of the other yoke member 10a or 10b during power transmission, allowing a larger working angle between the first and second yoke members 10a and 10b. The chamfered faces 34 of the coupler 30 farther increase the working angle range of the universal joint 100 according to the preferred teachings of the present invention by avoiding contact with the intermediate faces 14 of the first and second yoke members 10a and 10b. The angle □ (FIG. 8) between the first and second yoke members 10a and 10b can be larger than 40 degrees. The universal joint 100 according to the preferred teachings of the present invention can be utilized with high-speed power tools due to the reliable engagement between the coupling sections 23 of the first, second, third, and fourth pins 20a, 20b, 20c, and 20d and the engaging hole 42 of the inner end 41 of the engaging member 40 and reliable engagement between the peripheral edge 44 of the inner end 41 of the engaging member 40 and the grooves 22 of the first, second, third, and fourth pins 20a, 20b, 20c, and 20d. It can be appreciated that the coupling sections 23 of the first, second, third, and fourth pins 20a, 20b, 20c, and 20d together form a cylinder having circular cross sections (see FIG. 5). Undesired disengagement of the first, second, third, and fourth pins 20a, 20b, 20c, and 20d from the coupler 30 is avoided even though the universal joint 100 operates at high speed and is, thus, subjected to high centrifugal force. Thus, the coupler 30, the engaging member 40, the coupling ends 19 of the first and second yoke members 10a and 10b, and the first, second, third, and fourth pins 20a, 20b, 20c, and 20d together form a reliable pivotal device.

Now that the basic teachings of the present invention have been explained, many extensions and variations will be obvious to one having ordinary skill in the art. For example, the coupling ends 19 of the first and second yoke members 10a and 10b can be different in shapes. Similarly, the pins 20a, 20b, 20c, and 20d can be different in shapes. The power input end 11a of the first yoke member 10a can be manually driven or through a coupling member when desired.

The universal joint 100 according to the preferred teachings of the present invention can withstand high torque during operation due to provision of the coupler 30. Deformation of and damage to the arms 12 of the first and second yoke members 10a and 10b are mitigated. The life of the universal joint 100 is, thus, prolonged. The chamfered faces 34 of the coupler 30 avoid contact with the intermediate faces 14 of the first and second yoke members 10a and 10b and, thus, increase the working angle range of the universal joint 100 according to the preferred teachings of the present invention.

The universal joint 100 according to the preferred teachings of the present invention can rapidly and reliably be assembled without the risk of disengagement of the pins 20a, 20b, 20c, and 20d. Furthermore, the universal joint 100 according to the preferred teachings of the present invention can be utilized with high-speed power tools and work in a larger working angle without shaking. When replacement is required, the universal joint 100 according to the preferred teachings of the present invention can rapidly be detached to allow easy, rapid replacement of broken or damaged parts without discarding the whole universal joint 100.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A universal joint comprising:
a first yoke member including a first coupling end, with the first coupling end including a pair of spaced first arms, with the first arms including two mutually facing first inner faces defining a first spacing therebetween, with the first coupling end further including a first intermediate face interconnected between the first inner faces;
a second yoke member including a second coupling end, with the second coupling end including a pair of spaced second arms, with the second arms including two mutually facing second inner faces defining a second spacing therebetween equal to the first spacing, with the second coupling end further including a second intermediate face interconnected between the second inner faces, with one of the first and second yoke members including a power input end, with the other yoke member including a power output end; and
a coupler pivotably coupled with the first and second arms, allowing the first and second yoke members to respectively pivot about two pivot axes perpendicular to each other, with the coupler including opposite first and second faces slideably abutting with the first inner faces of the first yoke member, opposite third and fourth faces perpendicular to the first and second faces and slideably abutting with the second inner faces of the second yoke member, and opposite fifth and sixth faces perpendicular to the first, second, third, and fourth faces, with the first and second faces having a first width therebetween equal to the first spacing between the first arms, with the third and fourth faces having a second width therebetween equal to the second spacing between the second arms, with each of the first, second, third, and fourth faces having a length between the fifth and sixth faces, and with the length being larger than 0.6 times the first spacing and smaller than a distance from one of the two pivot axes to one of the first and second intermediate faces.

2. The universal joint as claimed in claim 1, with the length of each of the first, second, third, and fourth faces being larger than 0.75 times the first spacing and smaller than 0.95 times the distance from one of the two pivot axes to one of the first and second intermediate faces.

3. The universal joint as claimed in claim 1, with the coupler further including a chamfered face on each of two opposite sides of each of the fifth and sixth faces of the coupler.

4. The universal joint as claimed in claim 3, with each of the chamfered faces on the fifth face having a length extending between the third and fourth faces, and with each of the chambered faces on the sixth face having a length extending between the first and second faces.

5. The universal joint as claimed in claim 1, with the first arms having aligned first pivot holes, with the second arms having aligned second pivot holes,
with the fifth face of the coupler including a positioning hole defined therein, with the coupler further including two first pin holes respectively extending inward from the first and second faces, with the first pin holes being aligned with each other and in communication with the positioning hole, with the coupler further including two second pin holes respectively extending inward from the third and fourth faces, with the second pin holes being aligned with each other, in communication with the positioning hole, and perpendicular to the first pin holes,
with the universal joint further comprising, in combination:
first and second pins respectively extending through the first pivot holes of the first arms of the first yoke member and through the first pin holes of the coupler into the positioning hole, allowing the first yoke member to pivot relative to the coupler about one of the two pivot axes;
third and fourth pins respectively extending through the second pivot holes of the second arms of the second yoke member and through the second pin holes of the coupler into the positioning hole, allowing the second yoke member to pivot relative to the coupler about the other pivot axis; and
an engaging member mounted in the positioning hole of the coupler and movable between an engaged position engaged with the first, second, third, and fourth pins and a free position disengaged from the first, second, third, and fourth pins allowing detachment of the first, second, third, and fourth pins.

6. The universal joint as claimed in claim 5, with the engaging member including an inner end having an engaging hole, with each of the first, second, third, and fourth pins including an inner end having a coupling section engaged with the engaging hole of the engaging member in the engaged position, and with the coupling sections of the first, second, third, and fourth pins being disengaged from the engaging hole of the engaging member in the free position.

7. The universal joint as claimed in claim 6, with the inner end of each of the first, second, third, and fourth pins including a groove, with the inner end of the engaging member including a peripheral edge defining the engaging hole, with the peripheral edge of the engaging member being engaged with the grooves of the first, second, third, and fourth pins when the engaging member is in the engaged position, and with the peripheral edge of the engaging member being disengaged from the grooves of the first, second, third, and fourth pins when the engaging member is in the free position.

8. The universal joint as claimed in claim 7, with the coupling sections of the first, second, third, and fourth pins together form a cylinder having circular cross sections.

9. The universal joint as claimed in claim 8, with the first, second, third, and fourth pins being identical, and with the coupling section of each of the first, second, third, and fourth pins having substantially quarter circular cross sections.

10. The universal joint as claimed in claim 5, with the positioning hole of the coupler being a screw hole, and with the engaging member including outer threading threadedly engaged with the screw hole.

11. The universal joint as claimed in claim 6, with the engaging member father including an outer end having a groove adapted to be coupled with a tool for moving the engaging member between the engaged position and the free position.

12. The universal joint as claimed in claim 1, with each of the first arms of the first yoke member further including a first pair of opposite lateral sides between which one of the first inner faces extends, with a first recess being formed between each of the first pair of opposite lateral sides of each of the first arms and one of the first inner faces, with each of the first recesses being located between one of the two pivot axes and the first intermediate face, and with the first recesses of the first yoke member allowing entrance of the second arms of the second yoke member.

13. The universal joint as claimed in claim 12, with each of the second arms of the second yoke member further including a second pair of opposite lateral sides between which one of the second inner faces extends, with a second recess being formed between each of the second pair of lateral sides of each of the second arms and one of the second inner faces, with each of the second recesses being located between the other pivot axis and the second intermediate face, and with the second recesses of the second yoke member allowing entrance of the first arms of the first yoke member.
